(19) United States
(12) Patent Application Publication
(10) Pub. No.: US 2010/0255453 A1
(43) Pub. Date: Oct. 7, 2010

(54) Method and computer system of creating, storing, producing, and distributing examinations

(76) Inventor: Ludwig B. Chincarini, Claremont, CA (US)

Correspondence Address: Ludwig B. Chincarim, Ph.D., 521 Black Hills Dr., Claremont, CA, 91711, US

(21) Appl. No.: 12/384,169

(22) Filed: Apr. 2, 2009

(51) Int. Cl. G09B 7/00

(52) U.S. Cl. 434/322

(57) ABSTRACT

The invention is concerned with a method of creating and producing examinations. The method is closely connected with a computer-based exam creation software that provides the user or instructor with a suite of tools, allowing the design of exam questions and solutions for a particular course. The system allows allow the interaction of various instructors and other participants in the examination creation process. In order to facilitate the educational process, the invention provides the user with a easy-to-use interface to create new examination questions and solutions. The system stores the questions and solutions in a database. Other professors, instructors, or others can use the system to review questions posed by other instructors so as to have peer review. The questions are labeled with various parameters. The instructor can then choose several parameters for the exam which he/she would like to create. The system will then generate an exam in the format desired for the particular class the exam is being created for. The ability of professors to peer review, share exams from a database, and have logic on how to construct the exam improves the educational process. Firstly, it increases the standardization of exams across courses and professors in university, primary or secondary schools, or elsewhere. Secondly, it adds a robustness to exams through peer review. Thirdly, if offers efficiency to professors in terms of exam production. Finally, the sharing of exam questions improves the quality of examinations for students. The system can also be used for other organizations or entities to share and distribute questions and solutions, including publishers, electronic devices, and television shows.

### BACKGROUND OF THE INVENTION

1. Field of the Invention

The present invention relates to methods of teaching, particularly creating examinations for students in any department within a university and/or for teachers producing examinations for primary or secondary schools. The method enables a more standardized, robust, and easier-to-use system for producing examinations for students.

2. Description of the Related Art

University professors typically produce examinations in isolation from the rest of the faculty. Professors sometimes use past exams they have written or construct new exams based upon past questions that they have written. In primary and secondary schools, the practice is similar. Teachers typically produce questions for exams based upon their own work.

While these existing methods have worked well, they do not fully exploit a technological approach that provides a simple, efficient and effective method that could be used for many professors and teachers in transforming raw data and preparing examinations.

### BRIEF SUMMARY OF THE INVENTION

### I. Nature and Substance of the Invention

An examination for a course of a particular department in a university consists of questions in the form of (a) multiple-choice style (b) short-answer style (c) fill-in-the-blank style (d) matching-style (e) long-question problem (f) long-question essay. There may be other styles of questions, but most question-styles could be reduced to one of the styles describes above. The Multiple-Choice style can be of many forms, but usually consists of a question followed by 2 or more answers of which a student need pick one of them. The short-answer style is a question which relies on the student providing a short-answer, such as a number in the case of a numerical problem, or a word, in the case of word problem, or a short sentence, possibly. The fill-in-the-blank style consists of a sentence or phrase in which a few words are missing and the student needs to fill in the missing word or number by writing it below the question. A long-question problem is a more involved question. It is usually a quantitative question that is split into several parts. Each part of the question is assigned a certain number of points. The student usually must answer these questions using a Blue Book or separate paper. The exam could also be created so that sufficient writing space is contained with the examination document.¹ The long-question essay is a question that is usually answered by means of an essay from the student. Professors and teachers normally prepare examinations individually and in isolation from the other faculty or staff. Typically, a Professor will write a new exam prior to an examination, or he/she will alter a previously written exam and submit the exam, or he may mix old questions he has written with new questions that he will write for the exam. In some cases, Professors have even asked students to create a series of exam questions, which all students are aware of, which then will be chosen randomly by the Professor to use on the exam. ¹This is the preferred format, since it reduces the need for Blue Books and makes grading easier for the Professor or Teacher.

The present invention is applicable to the creation and production of examination questions and solutions. The computer system effectively transforms the questions and solutions into a suitable format based upon parameters in the system. The invention is useful in producing examinations efficiently by reducing the potential errors in questions due to peer review, by reducing the time required for Professors to design examinations through the use of pooled resources, by producing standardized examination for the students across an entire department in the university, by allowing a tailored level of difficulty for each exam that could be ultimately controlled by a faculty review committee, thus producing standardization across courses with a department and reducing the differentiation in student grades due to the taking of “easier” exams of the same material.

The invention is not only applicable to every university department, it is also applicable to primary and secondary teaching, where teachers prepare their own examinations. In fact, to some degree, the standardization features and pooling of exam questions may be even more important here. It may allow for certain school systems the standardization of examinations and levels of difficulty similar to the “O” and “A” level system of British secondary schooling. This will make the comparison of students across secondary schools standardized and fairer for university admissions.

### II. OBJECTS OF THE INVENTION

It is an object of the present invention to aid professors at university in preparing examinations for undergraduate students in a standardized, consistent way, while benefiting from the pool of questions. The software product will allow professors to produce examinations in a more reliable, peer-reviewed, standardized and easier-to-use format. It will also aid primary and secondary school districts in the preparation of consistent examinations across individual schools.

Another object of the present invention is to provide students with consistent formats for examinations in university and primary or secondary education that does not arbitrarily harm students to be at the “difficult school” or the bad school district.

Still another object of the present invention is to provide Professors and Teachers with access to a common pool of peer reviewed questions to facilitate the preparation of future exam questions and to provide for a more diversified and robust examination.

And yet another object of the present invention is to provide a consistent set of peer-reviewed solutions that would be available to students to understand the results from an examination.

Finally, the invention could also be used for producing homework assignments in courses throughout the university that are more similar to the examinations (since they come from the same pool of questions) and are of similar difficulty to the intended examination, thus improving the learning process for students.² ²It also eliminates the problems of students having to “guess” what will be on the examination and basically causing a differentiation in score due to those who “guessed” correctly.

### BRIEF DESCRIPTION OF THE DRAWINGS

FIG. 1 is a flow chart of the interaction between users (inputs) of the system and the production of examinations (output) of the system.

FIG. 2 is a flow chart of the more general form of the system when shared by several universities and/or schools or school districts.

FIG. 3 is a diagram of the basic system architecture, although this could vary.

### DETAILED DESCRIPTION OF THE INVENTION

A method of creating and producing examinations (both examination questions and solutions) in a pooled system for Professors and Teachers alike. The following description sets forth specific details only for purposes of explanation and to provide a complete understanding of the present invention. However, it is apparent to one skilled in the art that the present invention may be practiced by application of numerous modifications obvious to those skilled in the art without making use of the specific details shown and described, and that the present invention extends beyond embodiments described herein.

An online form will be installed in a university department, say the Economics department. Each professor in the department will have a username and password to log into the system. The Examiner software will have a database which stores the questions submitted by each professor. Suppose there is a professor teaching a course entitled “Investments” (FINC-241). He or she will then have access to write questions for such a course. Suppose the professor logs on. He or she will have the choice for type of question. For simplicity, we consider three types of questions. Type 1 is a multiple choice question, type 2 is a fill-in-the-blank type question, type 3 is a short-answer question, and type 4 is a long question.³ The professor will then type in the question along with the aid of the software to reduce the work burden.⁴ The software will have the ability to do automatic spell-checking in real-time. The professor will then also be prompted to type the suggested solution to the problem.⁵ The question will then be stored with the following tags:
Name of Professor
School of Professor
Department of Professor
Generic title of class
Actual code number
Category of Course (e.g. Securities Markets)⁶
Difficulty level of question (e.g. 1-5) ³One may wish to further sub-divide these sections, but the key is simplicity.⁴This software could be extended to allow for questions that require the scanning of documents, but this will make the software more complicated as well as the usability less so, since many professors may not have a computer with a scanner attached.

Once this information has been stored, the question will be pending for peer review. Each university department will decide on their criterion. Our database will mark an additional flag on whether or not a question has been peer reviewed. We suggest that at least one professor in the subject field, review the question at his leisure and input the following items:
Name of Reviewing Professor
Accept/Do not accept
Difficulty rating ⁵Note: The software should be equipped with an easy mathematical equation editor for many disciplines use this.⁶This software will contain generic lists of categories for each course and also have the option for an administrative assistant of the university or school to type in customized categories.

Once questions are stored in a database, a professor that is preparing an exam for his class will be able to generate a fully flushed out examination with virtually very little effort. The Professor will choose the following parameters:
Average difficulty of exam (1-5)
Number of questions of each category (e.g. 20 Multiple Choice, 5 short-answer, and 1 long question)
Source: Professor can choose source of questions (100% his own, random, 100% other professors, or any combination. The default will be random.)⁷
Timeliness. Professor can choose how old the questions have to be, since system will store last time examination questions were used in exam.) Default will be a company algorithm that offsets pros/cons.
Peer-reviewed or not (sometimes there may be no choice)
Time and Date of exam.
Course
Name of Professor
Rules for exam (e.g. closed book or open book. Software will have a dropdown to make things easier and professors will have their default settings) ⁷A more advanced sharing version of the system will allow users of the method to choose exams from Professors of other universities or schools and so on and so forth. The system is not limited to university professors or school teachers. The system would provide access levels so that virtually anyone could be a member of such a system.

Once the professor has chosen his parameters (Note: each professor can have his own default parameters), the system will generate an examination a variety of formats (e.g. Word, *.pdf, and others). It will also generate a document of solutions to the examination. Both of these can be saved electronically.

It should be pointed out, that the efficacy of the method of this invention becomes stronger the more Professors or Teachers that participate in the system. It provides greater robustness, a greater variety of questions, and higher diversity of questions. The system, however can function perfectly well even in the absence of a large number of participants. In the worst case of one user, the system functions still better than current methods, since the professors questions and answer key are stored in a database for later re-use in an efficient manner.

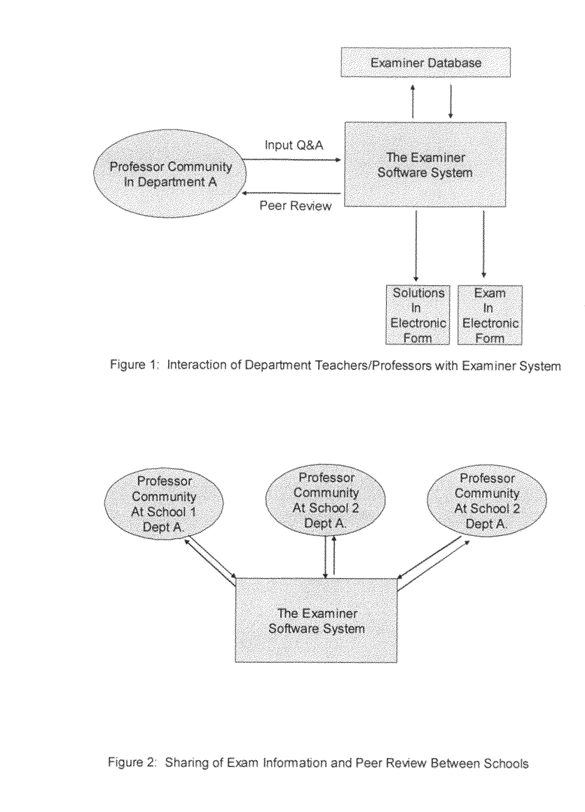

The concept of the invention is illustrated in FIG. 1 which shows the interaction between the professors/teachers and the software system.

The concept can be extended to a system between schools within a school board and/or similar departments across universities. This is illustrated in FIG. 2. University professors can share examination questions, peer review each other, and use each other's questions for examinations.

The system could function entirely without cost. However it also would have the ability to charge for questions depending on the source. For example, professors with the department of economics at Georgetown could freely share questions, or the university could charge for questions, such that a professor that produced more questions and people used his/her questions would get some kind of monetary transfer or university credit. Similarly, universities who shared in the system could charge each other for questions from their university or allow totally free sharing. This would be something agreed upon between departments and alterable with a change of preference in the software system.

We may further illustrate the procedures of the present invention by the following two specific examples.

### Example 1

Suppose Professor A of University XXX would like to produce an exam. He would first login to the system. The system would already have basic information about him, university, name, courses taught, etc. He would then choose which course he is writing a question for. In this case, he would choose “Investments” or Course Number “FINC-241”. He would also select among a group of categories for which the question falls under. In this case he chooses “Securities Markets”.⁸ He could begin by typing in questions for his exam. The software prompts him for the type of question. In this case, it is a multiple choice question, so he chooses that. He then uses the interface to type in the question.
Which of the following does not belong to the fixed income asset class?
   a. U.S. Treasury securities
   b. Municipal Bonds
   c. REITs
   d. Govt. Agency Securities ⁸There would be a drop-down menu of categories for this particular course. If his/her question did not fit in any of the predefined categories, then he would choose “Other.” The predefined categories can be constructed with the department of each school or a central administrator.

The software system will then ask him to describe the difficulty of the following question. In this case, he might rate this as a 1 (lowest difficulty). The system would then prompt him to enter the solution. In the case of a multiple-choice exam, it is quite easy and he would enter the letter “C”.

The system would then prompt him for further questions or to conclude his session. Once concluded, the question would be logged into the system as a completed question without peer review.

### Example 2

Suppose Professor B of University XXX entered the system. He would be prompted for several items, including whether or not he wanted to enter a question, review someone else's question, or produce an exam. Suppose he chose to review someone else's question. He would then be produced with a list of questions that have not been peer reviewed in his course area.⁹ Suppose he chose the question recently posted by Professor A. He would then be presented with the question and the solution. He would review this and then approve or not-approve the question/answer. If he approved, then he would essentially be done. If he did not approve, he should give a brief reason why in a box. Then he may log out. ⁹This is the default of the system, but he could choose to look at questions outside his field of expertise if the department allowed this feature.

### Example 3

When Professor A logs in to the system again, he will have a notice that tells him the questions that have been peer reviewed. In the case of unsuccessful reviews, he will be given the short description.

### Example 4

Professor A has an exam that evening. He decides to log in the system to produce an exam for his class. The system begins by asking him which course the exam is for. He stated “Investments”. The system then asks him, “How many MC Questions?” He types “20”. The system then asks “How many short-answer?” and he types “0”. The system then asks “How many fill-in-the-blank?” and he types “3”. The system then asks him “How many long answer-problems?” and he types “1”. The system asks him “How many long answer-essay?” and he types in “0”.

The system then asks him what the average of difficulty of this exam should be? He types in 2.5.

The system then asks him what types of questions he wishes to have: Percentage Written by Him, Percentage of Peer Reviewed, Exclusions (such as the one that was recently not approved), Timeliness of Exam. The system will use a proprietary optimization routine to match the Professor's requests. In all cases, the system will do the “best available” if the Professor's specific requests could not be handled. It will also state that it did the best available and what it could or could not do, so that the Professor is aware of it. The professor can always choose “Default” for all of these selections, which means that the system does a proprietary random choice amongst the question set.

Finally, the system will ask the Professor to click the topic areas for this exam. The professor will also have the ability to choose the weighting of each topic area, otherwise the system will equally weight topic areas.

Once complete, the professor will click “Produce Exam” and the software will produce an examination, a solutions document, and a output report on any issues with creating the examination (e.g. statistics such as Percent of Questions by Professor, Percent Peer-reviewed, Average Age of Questions, etc.).

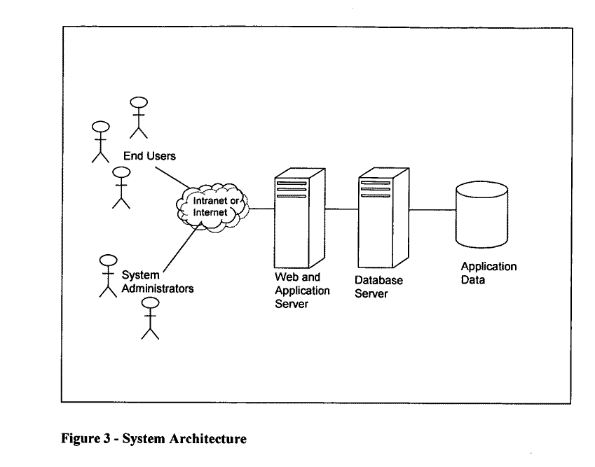

It should be realized that in the above description, precise relationships shown may be altered in varying degrees while achieving the essential objectives of the invention. Furthermore, since numerous modifications and changes will readily occur to those skilled in the art it is not desired to limit the invention to the exact realization and operation shown and described, and accordingly, all suitable modifications and equivalents are intended to be encompassed by the present invention, the scope of which is indicated by the appended claims.
The Examiner method of creating and producing examinations will be put to practice through the use of a software, which is briefly described below. However, the invention is by no means limited to this particular choice of bringing the method to practice.
The software system will be developed using a web-based architecture and can be implemented either on an intranet or on the Internet (see FIG. 3). End users will use the system using a web browser. System administrators will also use the system via a web browser interface. The system will be made up of a web and application server, a database server, and the application data. The application software will run on the application server and will store and retrieve the application data on the database server. The system can scale by increasing the performance and capacity of the servers and by adding servers.

End users and system administrators will log into the system through a secure login process requiring a user id and password. Once logged in, the user will be presented with the system user interface appropriate for the role of the person logged in. The user will interact with the system through menu options, links, and form fields.

1. A method for creating, storing, producing, and distributing examinations, problem sets, solutions, or displaying questions and solutions through an integrated system. The system transforms the original data based upon a variety of parameters into a new set of data for the end-user.

2. The method described in claim 1 enables professors, teachers, and others to generate examination questions, solutions, and problem sets through a software system which collects and organizes questions and answers.

3. The method described in claim 1 can also allow a variety of parameters to be entered in the system along with associated questions and solutions. These parameters are unique identifiers of the questions and solutions entered, and are not limited to the ones described in this document.

4. The method described in claim 1 may also be conducted over intranet or internet or other related medium to connect professors, teachers, and others through the system with permission rights to the degree of sharing of the information through various parameters not limited to the sharing restrictions discussed in this document.

5. The method described in claim 1 is not limited to the method of examinations and solutions documents discussed herein. The delivery of the questions and solutions can take a variety of forms as through a online test, through an electronic device, such as through a cell phone or other portable device and can be produced through a variety of mediums.

6. The method described in claim 1 will also contain a method of categorizing these questions and solutions according to various parameters not limited to the ones discussed in this comment so that the data can easily be stored and characterized for various end-user needs, such as exam creation or use in other mediums.

7. The method described in claim 1 will also allow for the sharing of information over the web or some other computer network that connects professors and/or teachers of one school to another school, and which can allow the sharing of certain types of data in the database depending on the choice of various parameters or sharing levels chosen by each school in the system.

8. The method described in claim 1 may also allows users to choose parameters which would restrict or make accessible questions, answers, and or other materials that they provide to the system according to some specified rule choice.

9. The method described in claim 1 may also allow for the choice of certain parameters, which would collect fees for use of such questions or solutions or use of the product in varying degrees from one particular member or a collection of members.

10. The method described in claim 1 may also allow for the separation of users that enter information and those that use the information according to certain parameters.

11. The method described in claim 1 can have a variety of types of questions and solutions output, but is not limited to these. Any format of questions and solutions, including drawings, pictures, or other objects that can be deemed a question or solution will be in this category.

12. The method described in claim 1 contains many parameters that may influence the system. This includes, but is not limited to, categories of questions (such as multiple-choice, short-answer, etc.), difficulty of questions, number of questions of each specific type, page layout for examination depending on specific parameters (such as space for answering questions in exam booklet, etc.), the document style format of examination (e.g. word, pdf, latex, etc.), the procedures for the examination (including date & time of exam, location of exam, duration of exam, etc.), the timeliness of questions in the exam (in other words, the average age of the exam or the constraint that the question has not been used in the recent past), the choice of exam questions from the database, including but not limited to, the random choice, to a choice based upon school, based upon originator of questions, based upon category distribution on topics in the course, and generally based upon any distribution of any of the parameters described in this document, but not limited to these parameters discussed.

13. The method described in claim 1 may also allow for the manipulation of the computer-based educational system where the administrators of a department, school, or collection of schools can specify parameters such that examination questions produced by the system must follow some chosen parameter set that cannot be changed by anyone but the central administrator. For example, the central administrator could choose the average level of difficulty of the every exam created.

14. The method described in claim 1 is not limited to straight questions and answers, but can be questions and answers based upon a case study or book or TV show or any other medium in which questions and answers could be produced.
